(19) United States
(12) Patent Application Publication
(10) Pub. No.: US 2026/0140503 A1
(43) Pub. Date: May 21, 2026

(54) AUTONOMOUS UAV VISUAL NAVIGATION SYSTEM

(71) Applicants: KING FAHD UNIVERSITY OF PETROLEUM AND MINERALS, Dhahran (SA); Saudi Data and Artificial Intelligence Authority (SDAIA), Riyadh (SA)

(72) Inventors: Hussein Salem Ali Bin SAMMA, Dhahran (SA); Sami ELFERIK, Dhahran (SA)

(73) Assignees: KING FAHD UNIVERSITY OF PETROLEUM AND MINERALS, Dhahran (SA); Saudi Data and Artificial Intelligence Authority (SDAIA), Riyadh (SA)

(21) Appl. No.: 18/948,711

(22) Filed: Nov. 15, 2024

(51) Int. Cl. G05D 1/243; B64U 20/87; G05D 1/633; G05D 101/15; G05D 109/20; G06V 10/764; G06V 10/776; G06V 10/778; G06V 10/82; G06V 20/17; G06V 20/58

(52) U.S. Cl. CPC G05D 1/2437; B64U 20/87; G05D 1/633; G06V 10/764; G06V 10/776; G06V 10/7792; G06V 10/82; G06V 20/17; G06V 20/58; B64U 2201/10; G05D 2101/15; G05D 2109/20

(57) ABSTRACT

A system, method, and non-transitory computer readable medium for autonomous vehicle navigation and visual inspection utilizing a deep Q-network and reinforcement learning includes at least one camera mounted to the vehicle for capturing continuous image frames of a scene, and processing circuitry configured with a reinforcement learning engine that generates a next control action for vehicle movement based on the captured image frames and a reward for a previous control action. A self-supervised learning engine fine-tunes the deep Q-network, and a vehicle actuator maneuvers the vehicle accordingly. The visual inspection system includes a remote display terminal, an unmanned aerial vehicle (UAV) with an embedded transceiver for communicating captured image frames of a scene to the remote display terminal, and processing circuitry configured to control movement of the UAV to avoid moving objects based on the deep Q-network and reinforcement learning engine, displaying the captured image frames on the remote display terminal.

### STATEMENT REGARDING PRIOR DISCLOSURE BY THE INVENTORS

Aspects of this technology are described in an article H. Samma and S. El-Ferik, “Autonomous UAV Visual Navigation Using an Improved Deep Reinforcement Learning,” in IEEE Access, vol. 12, pp. 79967-79977, 2024, doi: 10.1109/ACCESS.2024.3409780, which is herein incorporated by reference in its entirety.

### STATEMENT OF ACKNOWLEDGEMENT

Support provided by the Deanship of Scientific Research (DSR) at King Fahd University of Petroleum & Minerals (KFUPM), Dhahran, Saudi Arabia, is gratefully acknowledged.

### BACKGROUND

### Technical Field

The present disclosure is directed to a method and system for autonomous navigation of unmanned aerial vehicles (UAVs) using vision-based methods and deep reinforcement learning in dynamic environments.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Unmanned aerial vehicles (UAVs) are increasing in utilization across various applications due to their high mobility, ease of deployment, and low maintenance costs. However, autonomous navigation for UAVs remains a challenging task, particularly in complex environments. One approach to autonomous navigation is to use machine vision. UAVs can be implemented with vision-based devices for autonomous navigation enabling operation in diverse settings, such as indoor and outdoor environments under various weather conditions.

UAVs that use vision-based navigation methods are based on computer vision techniques that interpret the captured scenes of the environment with the objective of navigating toward a desired destination. For instance, in one know method, the twin delayed deep deterministic policy gradients (TD3) method has been implemented for UAV navigation in multipleobstacle environments. The algorithm implemented for these navigation methods was trained in a simulated environment where the UAV learned to navigate to a target destination while avoiding obstacles. However, the simulated environment used was relatively simple and did not account for real three-dimensional moving objects, such as humans.

Other UAV navigation methods have explored different deep learning approaches. One such approach adopted a deep Q-network (DQN) agent with a primary objective of enabling the UAV to visit all mobile targets with the least energy consumption. This method was evaluated in both simulation and real-world fields, demonstrating that the DQN agent could achieve reasonable performance. Nevertheless, DQN agents and the respective algorithms typically require a large amount of training data to effectively learn and encode the navigational environment.

In another navigation method, a two-stage visual navigation method has shown to be effective in both simulated and real-world environments. The first stage involved estimating position of the robot, while the second stage was trained to navigate the robot to a target destination using the estimated positions. Additionally, a convolutional neural network (CNN)-based scheme for automatic obstacle avoidance has been implemented for UAV navigation. The scheme includes training a CNN algorithm using input images captured by a frontal camera of the UAV to forecast both the steering angle and the collision probability along a path of the UAV.

Despite the progress of UAVs having visual-based navigation with deep reinforcement learning, the aforementioned approaches have limitations when operating in dynamic environments containing moving obstacles. Handling dynamic environments poses significant challenges because deep reinforcement learning techniques require a larger number of training trials and training data to comprehend the navigational environment when obstacles are relocated or in motion. The necessity for such techniques that can efficiently adapt to changes in dynamic environments without extensive retraining remains a challenge.

Therefore, there exists a need for a method and system for UAV autonomous navigation that effectively addresses the challenges posed by dynamic environments with moving obstacles. Such a system needs to enhance navigation performance, improve obstacle avoidance capabilities, and operate efficiently with limited reliance on extensive training data, thereby providing a more robust and adaptable solution for UAV navigation in complex and changing environments.

### SUMMARY

In an exemplary embodiment, a navigation system for an autonomous vehicle is described. The navigation system comprises at least one camera mounted to the vehicle for continuously capturing image frames of a scene. The navigation system further comprises processing circuitry configured with a reinforcement learning engine that receives the captured image frames and generates a next control action by a deep Q-network for controlling movement of the vehicle based on a current state of the vehicle and a reward for a previous control action. The navigation system further comprises a self-supervised learning engine for fine-tuning the deep Q-network, wherein the self-supervised learning engine is configured to input a triplet of three images, one positive, one augmented, and one negative, to the backbone network, and use a contrastive loss function to estimate a contrastive loss value. The navigation system further comprises a vehicle actuator for maneuvering the vehicle based on the next control action.

In another exemplary embodiment, a visual inspection system is described. The visual inspection system comprises a remote display terminal configured with a terminal transceiver. The visual inspection system further comprises an unmanned aerial vehicle (UAV) comprising an embedded transceiver for communicating with the remote display terminal via the terminal transceiver. The UAV further comprises at least one camera mounted to the UAV for continuously capturing image frames of a scene, wherein the scene includes at least one object. The UAV further comprises processing circuitry configured with a reinforcement learning engine receiving the captured image frames and generating a next control action by a deep Q-network for controlling movement of the vehicle to avoid the at least one moving object based on a current state of the vehicle and a reward for a previous control action. The UAV further comprises a self-supervised learning engine for fine-tuning the deep Q-network, wherein the self-supervised learning engine is configured to input a triplet of three images, one positive, one augmented, and one negative, to the backbone network, and use a contrastive loss function to estimate a contrastive loss value. The UAV further comprises a vehicle actuator for maneuvering the UAV based on the next control action. The embedded transceiver is configured to transmit the captured image frames to the remote display terminal. The remote display terminal is configured to display the captured image frames.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a navigation environment within which a navigation system for an unmanned aerial vehicle (UAV) is deployed, in accordance with an exemplary aspect of the disclosure;

FIG. 1B illustrates a depth view of the environment captured by the onboard camera of the UAV 106,

FIG. 2A illustrates a visual inspection system for autonomous visual navigation in dynamic environments

FIG. 2B illustrates an unmanned aerial vehicle UAV, according to certain embodiments.

FIG. 3 illustrates a navigation system architecture for autonomous UAV operation in dynamic environments, according to certain embodiments.

FIG. 4 illustrates an obstacle detection engine integrated into a UAV navigation system, according to certain embodiments.

FIG. 5A shows a sample image used for training the obstacle detection engine, according to certain embodiments.

FIG. 5B illustrates another sample image used for training the obstacle detection engine, according to certain embodiments.

FIG. 6A illustrates a flowchart for integrating the UAV navigation system with an obstacle detection engine, according to certain embodiments.

FIG. 6B shows an extension of the process flow of the obstacle detection engine with the self-supervised learning system of the UAV, according to certain embodiments.

FIG. 7 illustrates an UAV framework used for controlling UAV navigation within a 3D outdoor simulation environment, according to certain embodiments.

FIG. 8A illustrates a graph of the loss curve for the DQN during the training phase, according to certain embodiments.

FIG. 8B illustrates a graph the loss curve for the self-supervised DQN during the training phase, according to certain embodiments.

FIG. 9 illustrates the confusion matrix for the obstacle detection engine integrated into the self-supervised Deep Q-Network (DQN) architecture, according to certain embodiments.

FIG. 10 provides a visual snapshot of the navigation environment during the obstacle detection process, according to certain embodiments.

FIG. 11 illustrates the performance comparison between the self-supervised DQN and Double DQN and Dueling DQN, according to certain embodiments.

FIG. 12 is an illustration of a non-limiting example of details of computing hardware used in the UAV navigation system, according to certain embodiments.

FIG. 13 is an exemplary schematic diagram of a data processing system used within the UAV navigation system, according to certain embodiments.

FIG. 14 is an exemplary schematic diagram of a processor used with the UAV navigation system, according to certain embodiments.

FIG. 15 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure address the challenge of autonomous vehicle navigation in dynamic environments, where conventional systems have limitations in detecting and avoiding obstacles in real-time. A navigation system of the present disclosure implements a reinforcement learning engine integrated with a deep Q-network, further enhanced by a self-supervised learning engine, resulting in adaptive and precise navigation based on real-time environmental data. The navigation system renders efficient obstacle avoidance, both for stationary and moving objects, while maintaining optimal performance in constantly changing surroundings.

The navigation system is for an autonomous vehicle that is equipped with at least one camera that captures continuous image frames of the environment. These frames are processed by the reinforcement learning engine to generate the next control action based on a current state of the vehicle and a reward for the previous action. A self-supervised learning engine fine-tunes a deep Q-network in the reinforcement learning engine, improving the system ability to adapt to complex environments over time.

Additionally, the navigation system includes an obstacle detection engine to classify objects as obstacles or non-obstacles and generate appropriate control actions to avoid potential collisions. This combination of advanced reinforcement learning, self-supervised learning, and obstacle detection ensures reliable and efficient autonomous vehicle navigation.

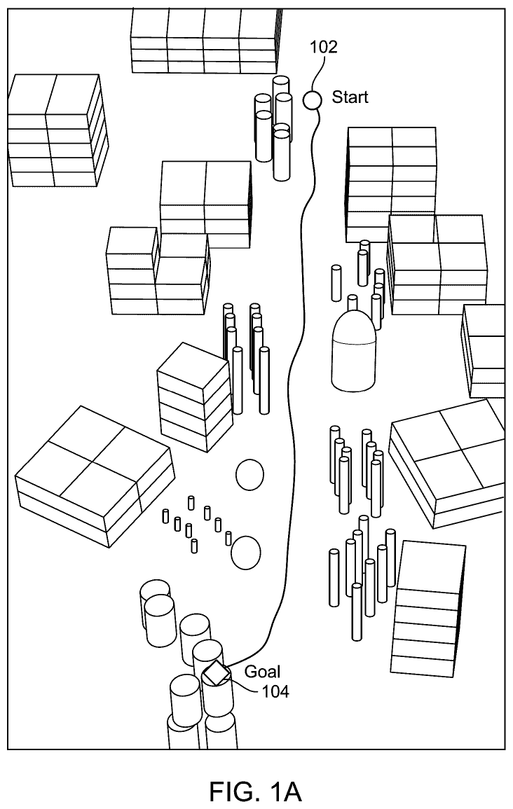

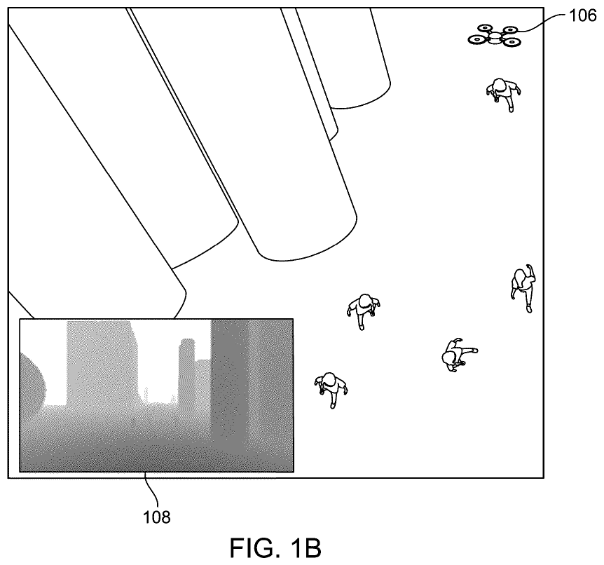

FIG. 1A illustrates an exemplary navigation environment within which an unmanned aerial vehicle (UAV) is deployed. The navigation system of the UAV is configured for autonomous operation in environments containing both stationary objects and dynamic objects. The navigation system incorporates several features enabling real-time detection and avoidance of obstacles. The UAV follows an optimal navigation path denoted by a start point 102 and a destination location 104. The optimal navigation path is dynamically calculated by onboard systems based on sensor data and environmental factors. The UAV adjusts this path continuously as new information is gathered regarding its surroundings, with the goal of efficiently reaching a destination location while avoiding collisions.

The UAV may face challenges pertaining to real-time navigation and obstacle avoidance capabilities in the navigation environment. The navigation environment may be either an urban city area or a remote, less populated region, with each scenario presenting unique obstacles for the UAV to navigate.

In a typical city environment, the UAV could be deployed in a bustling metropolitan area, where a variety of stationary and dynamic objects are present. For instance, the UAV would need to navigate through streets lined with tall buildings, overpasses, and bridges, all of which represent stationary obstacles. Meanwhile, the dynamic objects could include pedestrians crossing streets, animals such as dogs walking on sidewalks, and even delivery drones or commercial aircraft operating at varying altitudes. There might also be birds flying across the UAV flight path, as well as ground-based vehicles like cars, trucks, and bicycles that frequently change positions. In such a densely populated urban area, obstacles are constantly monitored and the navigation path is adjusted to avoid collisions with these dynamic entities.

For example, the UAV may be deployed to deliver a package in a busy city district. As it follows its optimal path, it encounters various obstacles such as high-rise buildings, billboards, pedestrians crossing streets, and other UAVs or drones performing similar tasks. The UAV must adjust continuously to avoid these moving and static obstacles while maintaining an efficient route to the destination. Birds, which could pose a risk to aerial navigation, may fly close to the UAV, requiring swift real-time adjustments to the flight path.

Alternatively, the UAV might operate in a remote, rural area. In such an environment, the stationary objects might include large trees, power lines, or mountainous terrain, whereas dynamic obstacles could involve wildlife such as deer or other animals crossing the UAV flight path. Other dynamic obstacles could include low-flying aircraft such as crop-dusting planes or helicopters, as well as birds of prey circling at higher altitudes. In this context, the UAV may be tasked with surveying farmland, delivering supplies, or conducting search-and-rescue operations in a less structured environment with fewer man-made obstacles.

For instance, while flying over agricultural fields, the UAV encounters a flock of birds or a herd of livestock, both requiring real-time adjustments to the flight path. The environment may also include vast, open fields with few visual references, challenging the UAV sensors to accurately determine and maintain the optimal navigation route.

The UAV is equipped with one or more sensors, including at least one camera, which continuously captures image frames of the surrounding scene. These image frames provide crucial data regarding the spatial positioning of obstacles, both stationary and dynamic. The camera, which may be an imaging sensor with high resolution capabilities, serves multiple functions such as assisting in take-off and landing, providing surveillance footage, and aiding in navigational decision-making. The camera may also operate in conjunction with external cameras, such as those located at a ground station, enhancing the overall situational awareness of the UAV. In some aspects, the camera may include multi-sensor modules to gauge the distance between the UAV and nearby objects, adjusting its focus or processing image data accordingly.

FIG. 1B illustrates a depth view of the environment captured by the onboard camera of the UAV 106. The view represents a 3D projection of the obstacles, providing the UAV 106 with depth data. A frame 108 is a representation of the depth data. The depth data includes information on both the spatial positioning and the distances of objects relative to the UAV 106. The depth data is utilized by the UAV 106 to make real-time adjustments to its flight path, avoiding collisions by calculating safe distances from obstacles.

In addition to basic obstacle avoidance, the depth data is utilized to predict the future movements of dynamic objects. By continuously updating this data, the UAV can adjust its navigation path to avoid any unpredictable shifts in the positions of moving entities. This capability is particularly important when navigating crowded or complex environments, where obstacles are likely to change position frequently.

As noted above, various techniques have been developed to enhance UAV navigation systems, focusing on different aspects of obstacle avoidance and efficient route planning. Among these, deep reinforcement learning (DRL) has been implemented for UAV applications, including methods aimed at avoiding collisions with static and dynamic obstacles. For instance, saliency detection-based reinforcement learning approaches have been implemented to predict the positions of obstacles, such as flying objects, by utilizing convolutional neural networks (CNN). However, these methods often rely on the accuracy of the detection algorithm, which may not always translate into improved navigation performance. Moreover, several techniques have explored reward-driven obstacle avoidance methods using CNNs and U-Net-based networks, yet these approaches typically do not account for moving obstacles such as pedestrians, thereby limiting their effectiveness in dynamic environments.

One technique involves the application of an actor-critic network for navigating UAVs in multi-obstacle scenarios involving static obstacles, such as cubes and cylinders. While the method demonstrated success in randomly moving obstacles during testing, the method did not address the complexities of navigation in environments with dynamic obstacles like pedestrians, which can significantly increase the difficulty of real-time navigation. Another line of research examined indoor UAV localization using visual cues in GPS-denied environments, yet this method suffered from occlusion issues, particularly in environments with poor visibility or obstructed landmarks.

Other relevant techniques include two-stage visual navigation approaches, wherein reinforcement learning (RL) agents learn how actions of the UAV affect its environment, and position estimation methods are developed using convolutional neural networks (CNNs). These methods, while effective in controlled simulations, face challenges when applied in real-world settings, particularly when navigating through complex 3D spaces with both static and dynamic obstacles. The autonomous motion control of UAVs has also been explored through the application of asynchronous curriculum experience replay (ACER), which exhibited improvements in convergence times compared to traditional deep deterministic policy gradient (TD3) algorithms.

Additionally, cooperative navigation for UAV swarms has garnered attention, focusing on fault-tolerant systems and decentralized decision-making strategies for multi-UAV systems. These methods are based on visual perception and communication-based data to ensure swarm coordination, even when communication is disrupted. However, such strategies often require extensive offline optimization and computational resources, which may limit their adaptability in dynamic or evolving environments.

Other work has introduced new UAV navigation methods, particularly in indoor settings, using visual SLAM, semantic segmentation, and decision-making algorithms to enhance autonomous navigation. Deep learning-based methods have also been applied to UAV exploration in unknown environments, incorporating techniques such as invalid action masking to improve learning efficiency. Collision avoidance systems utilizing computer vision techniques have been developed for indoor drone operations, yet these methods are typically tailored to small-scale experiments and may require further optimization to be effective for larger UAV systems or swarms.

Further to these existing methods, the navigation system introduced in FIGS. 1A and 1B addresses the complexities of dynamic environments, particularly those involving obstacles such as stationary buildings and moving pedestrians. The present disclosure uses a reinforcement learning-based vision navigation system. The present disclosure integrates a self-supervised learning mechanism with an obstacle detection engine, enabling the UAV 106 to improve its navigation performance by making real-time adjustments based on the sensor data collected from its surroundings. By combining these methodologies, the UAV 106 is able to navigate longer distances while avoiding both stationary and dynamic obstacles, demonstrating significant advancements over prior art approaches.

In addition to conventional reinforcement learning techniques, the integration of self-supervised learning has proven to be highly effective for UAV 106 navigation, particularly in tasks such as path planning, depth estimation, and object tracking. Self-supervised learning enables the UAV 106 to learn from its environment without the need for extensive labeled data, resulting in more autonomous decision-making. For instance, with self-supervised learning, a UAV 106 can evaluate and predict unexpected events or changes in its surroundings through a process referred to as “expected surprise.” By using its own sensor data and world modeling, the UAV 106 can adapt its behavior more quickly and efficiently, avoiding the limitations of conventional reinforcement learning, which often requires a significant amount of trial and error to perform effectively.

In terms of depth estimation, self-supervised learning has facilitated obstacle avoidance by allowing UAV 106 to derive spatial information solely from images, without relying on ground truth depth data or other external inputs. Using such method, the UAV 106 accurately estimates the distance to obstacles in real-time, thereby enhancing its ability to autonomously navigate complex environments. The result is a more flexible and continuous learning process, which is particularly valuable in dynamic environments where obstacles are constantly shifting.

Furthermore, self-supervised learning has been applied to UAV 106 tracking tasks, allowing the UAV 106 to generate meaningful feature representations of its environment without human-provided annotations. By using contrasting instances, the UAV 106 refines its understanding of objects within its field of view, improving its tracking capabilities. The self-supervised learning reduces the need for manual intervention and enhances scalability and adaptability of the system to diverse operational scenarios.

In conjunction with the depth view illustrated in FIG. 1B, the navigation system employed by the UAV 106 integrates self-supervised learning to optimize its performance in real-time. The depth data, captured by the UAV 106 sensors, is processed using self-supervised algorithms to refine understanding by the UAV 106 of its surroundings, so that the UAV 106 can make informed decisions about its trajectory while avoiding both stationary and dynamic objects. By utilizing the learning methodology, the UAV 106 enhances its obstacle avoidance capabilities and overall navigation efficiency, significantly improving its ability to operate in complex, unpredictable environments.

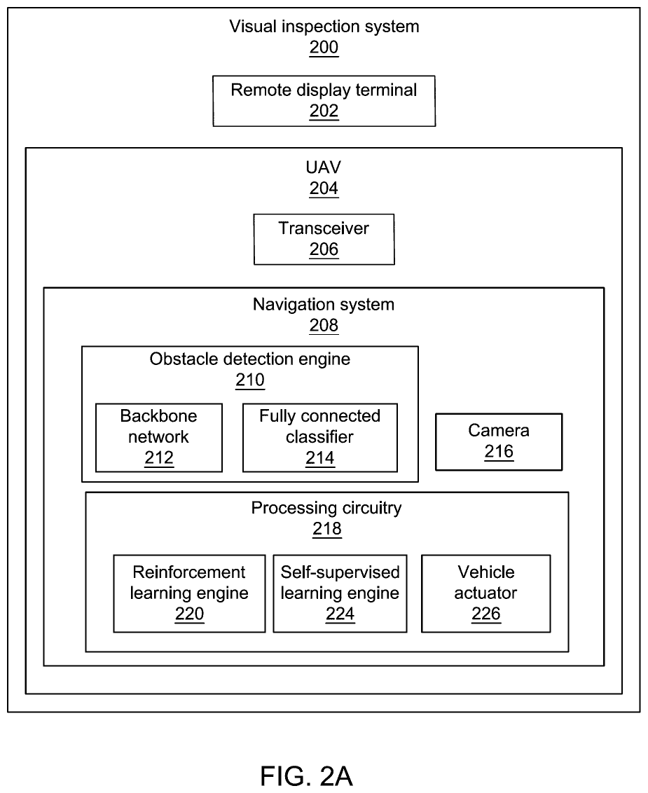

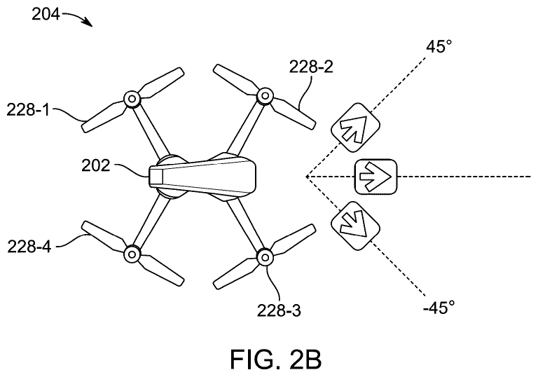

FIG. 2A illustrates a visual inspection system 200 for autonomous visual navigation in dynamic environments. The visual inspection system 200, alternatively referred to as a system 200, mainly includes a remote display terminal 202, a UAV 204 including a transceiver 206 and a UAV navigation system 208. The UAV navigation system 208 is a representative of the navigation system as described in FIG. 1A and FIG. 1B. The UAV navigation system 208 is configured to navigate the UAV 204 from an initial starting location to a destination location. The UAV 204 is configured to operate autonomously and is equipped with a set of sensors to capture environmental data in real-time, enabling it to follow a dynamically calculated navigation path.

The navigation environment includes a combination of fixed obstacles, such as buildings or immovable structures, and movable obstacles, such as pedestrians or vehicles, whose positions change over time. The UAV 204 processes input from its onboard sensors to avoid both types of obstacles, continuously adjusting its trajectory based on the spatial distribution and movements of the obstacles.

The navigation path is dynamically recalculated as the UAV 204 moves through the environment, so that the UAV 204 avoids obstacles while progressing toward the target location. The UAV 204 relies on a deep reinforcement learning algorithm, which utilizes the real-time sensor data to compute optimal actions that keep the UAV on the optimal path, avoiding collisions with both fixed obstacles and movable obstacles.

The remote display terminal 202 of the system 200 serves as an interface for a human operator. The remote display terminal 202 is configured to communicate wirelessly with a UAV 204 via the transceiver 206. The remote display terminal 202 can be a mobile device such as a laptop, tablet, or specialized handheld controller with a graphical user interface (GUI). The GUI may display real-time data such as location of the UAV, telemetry, and camera feed, and provides control options for managing flight parameters. The remote display terminal 202 may also include functions to configure flight paths, manage camera settings, and initiate safety procedures, such as emergency landing protocols. The communication between the remote display terminal 202 and the UAV 204 may be implemented using wireless communication technologies such as Wi-Fi, cellular networks (4 g, 5 g), or satellite communications, depending on operational requirements.

The UAV 204 comprises a transceiver 206 that facilitates two-way communication with the remote display terminal 202. The transceiver 206 receives instructions from the remote display terminal 202 and relays operational data, such as video feed, telemetry, and obstacle information, back to the operator. The transceiver 206 may also serve as a communication hub for exchanging data between the onboard systems of the UAV 204 and external devices, such as ground-based sensors or other UAVs in a coordinated operation.

The UAV 204 further includes the navigation system 208 configured for managing autonomous flight, obstacle detection, and real-time adjustments to the flight path. The navigation system 208 comprises an obstacle detection engine 210 configured for detecting objects in the flight path and making necessary adjustments to avoid collisions. The obstacle detection engine 210 includes a backbone network 212 and a fully connected classifier 214. The backbone network 212 is a convolutional neural network that performs image classification by processing the image data from a camera 216 mounted on the UAV 204. The fully connected classifier 214 classifies detected objects as obstacles or non-obstacles based on the processed image data.

The camera 216 may be a high-resolution imaging sensor implemented for capturing both still images and video in various lighting conditions. The camera 216 may support resolutions ranging from 1080p to 4 k, or even higher, depending on the operational requirements. In some aspects, the camera 216 may also include thermal or multispectral imaging capabilities to detect heat signatures or specific materials, making it useful for applications such as search and rescue, infrastructure inspection, and environmental monitoring. Additionally, the camera 216 may provide navigational assistance during take-off and landing by capturing the terrain and surrounding obstacles, as well as the environment while in-flight.

The UAV 204 further includes a processing circuitry 218, which controls all autonomous navigation functions. The processing circuitry 218 includes a reinforcement learning engine 220, a self-supervised learning engine 224, and a vehicle actuator. The reinforcement learning engine 220 generates navigation actions based on a DQN, and processes the current state of the UAV 204, including its position and any detected obstacles, to determine the optimal next move, such as changing the flight path or speed. The self-supervised learning engine 224 fine-tunes the DQN based on data captured during flight. The self-supervised learning engine 224 uses depth images stored in a replay buffer and applies contrastive learning techniques to speed up the learning curve and to improve the accuracy of the obstacle detection and navigation decisions.

The vehicle actuator 226, controlled by the processing circuitry 218, executes the navigation actions determined by the reinforcement learning engine 220. The navigation actions may include changing the UAV speed, altitude, direction, or any other necessary adjustments to ensure safe and effective operation.

In some aspects, the obstacle detection engine 210 may include additional sensors, such as lidar or radar for providing 3d mapping of the surrounding environment. Using the additional sensors the UAV 204 can navigate more complex environments, such as urban areas with high-rise buildings or densely forested areas.

The remote display terminal 202, in other aspects, can control multiple UAVs simultaneously, displaying live video feeds and telemetry data from each. The remote display terminal 202 is particularly implemented to execute large-scale inspection tasks, such as monitoring infrastructure over a wide geographic area. The operator may switch between UAVs or manage a coordinated flight plan for multiple UAVs using the remote display terminal 202.

Additionally, the remote display terminal 202 may be equipped with a plurality of graphical tools for flight path planning, geofencing, and contingency management. The operator uses the graphical tools to define no-fly zones, create automatic return-to-home instructions in case of low battery, or pre-program emergency landing zones.

In some aspects, external cameras, such as the imaging sensors located at ground stations, may provide supplementary navigation data to the UAV 204, especially in environments where GPS signals are weak or unavailable. The external cameras are utilized for the UAV 204 to navigate with greater precision by providing additional viewpoints and improving overall situational awareness.

The system 200 supports real-time autonomous navigation, obstacle detection, and data capture, making it suitable for a wide range of applications, from infrastructure inspection to environmental monitoring. The integration of the reinforcement learning engine 220, the self-supervised learning engine 224, and the obstacle detection engine 210 thus renders effective navigation of the UAV 204 through complex environments while capturing high-quality visual data and transmitting it to the operator through the remote display terminal 202.

FIG. 2B illustrates the UAV 204. The UAV 204 is depicted performing navigation actions based on the information provided by a DQN, as a part of onboard navigation and obstacle avoidance system of the UAV 204.

In one example, the DQN receives depth data captured by a front camera of the UAV 204. The depth data represents a real-time 3D view of surroundings of the UAV 204, which is processed by the navigation system 208, as shown in FIG. 2A, to generate a control action. The control action is determined based on the current state of the UAV 204 in its environment and the calculated reward value from previous actions. The reinforcement learning engine 220 as described in FIG. 2A, processes the captured depth images, computes a reward based on the difference between previous distance of the UAV to the target location and the current distance, and determines the optimal next control action.

The UAV 204 has the capability to perform a plurality of movement actions in its action space, as depicted in FIG. 2B. The movement actions include forward movement, movement along a 45-degree angle, and movement along a −45-degree angle. The movement actions are based on the spatial positioning of the UAV 204 with respect to surrounding obstacles, which may include both stationary and moving objects. The processing circuitry 218, as described in FIG. 2A, calculates the next control action and maneuvers the UAV 204 accordingly to avoid obstacles while maintaining efficient navigation toward the designated destination location.

In particular, the UAV 204 is configured for adjusting its trajectory based on the output from the self-supervised learning engine 224, as described in FIG. 2A, which fine-tunes the backbone network of the DQN. The backbone network is configured for processing the depth images captured by the camera, enabling the system to generate precise navigation actions. The self-supervised learning engine 224 uses a contrastive loss function to optimize a decision-making process of the UAV by analyzing depth image triplet, composed of positive, negative, and augmented images, to estimate loss values and refine movements of the UAV.

The reward function determines the UAV control actions. It is designed to calculate a reward value that reflects progress of the UAV 204 toward its destination location while minimizing the risk of collision with obstacles. The reward function measures the difference between previous distance of the UAV 204 to the destination and the current distance after executing a control action. This dynamic adjustment allows the UAV 204 to continuously refine its flight path based on real-time environmental changes.

The UAV 204 also incorporates an obstacle detection engine 210, which uses the depth data from the front camera to detect obstacles in the environment. The obstacle detection engine 210 includes a backbone CNN network 212 and a fully connected classifier 214 that outputs the obstacle class, enabling the UAV to distinguish between different types of obstacles. The DQN receives this information and adjusts the UAV movements to avoid collisions, taking into account both stationary and moving objects.

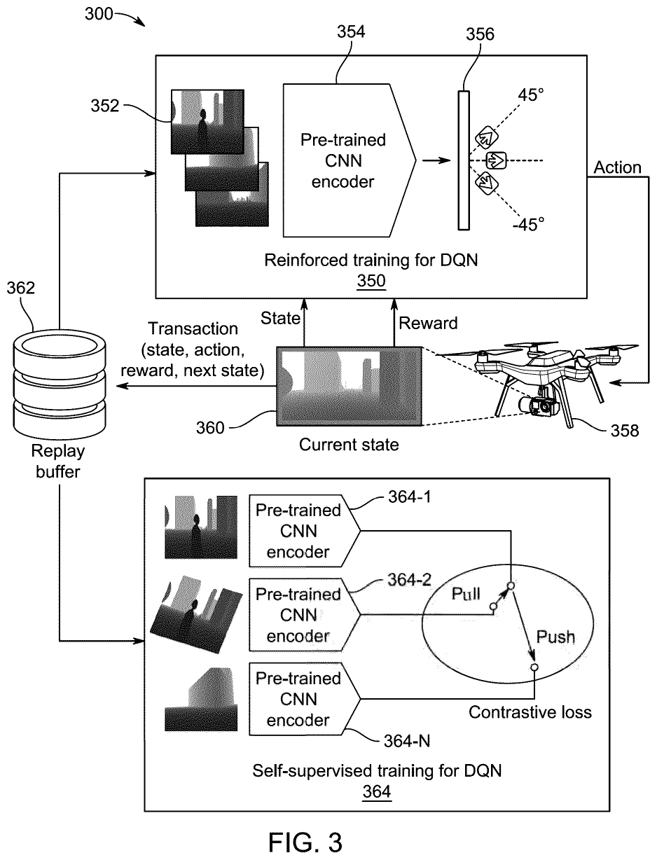

FIG. 3 illustrates a navigation system architecture 300 for autonomous UAV operation in dynamic environments. The architecture 300 comprises a UAV 358 equipped with a plurality of sensors, including an onboard depth camera that generates depth images, providing real-time data about surroundings of the UAV 358, including the positions of both fixed and dynamic obstacles.

The system architecture 300 operates using two phases of training. First, reinforced learning, and second self-supervised learning. The training phases are based on deep learning techniques for real-time navigation. During the reinforced learning for DQN phase 350, the system processes the current state 360, derived from the depth images 352. The current state 360 contains data regarding spatial position of the UAV 358 relative to fixed obstacles and dynamic obstacles, such as moving pedestrians or vehicles. Based on the data, the UAV 358 computes the optimal action required to navigate safely toward its destination while avoiding collisions.

The system 300 uses the DQN to predict the best course of action based on the current state 360. The DQN includes a pre-trained convolutional neural network (CNN) encoder 354 with multiple convolution layers. For example, in a preferred implementation, the DON utilizes ResNet50, where the final classification layer is replaced with a fully connected network 356 of neurons. Multiple convolutional layers of ResNet50 extract hierarchical features from the input depth images 352. The earlier layers of the CNN focus on detecting low-level features such as edges and textures, while the deeper layers capture more abstract representations like object shapes and spatial relationships. These features are passed through several residual blocks to preserve the gradient flow and reduce the chance of vanishing gradients during backpropagation, which is critical for training deeper networks.

In addition to ResNet50, alternative CNN architectures, such as InceptionV3, DenseNet, or even fully convolutional networks (FCNs), can be employed for feature extraction in the system. For example, FCNs are particularly useful for pixel-level scene segmentation and can provide a more detailed understanding of the environment. This is particularly relevant for detecting small, distant obstacles. Autoencoders can also be integrated into the architecture to perform dimensionality reduction on the depth images, encoding high-dimensional input data into compressed representations and reconstructing the data back for further processing. These autoencoders discard redundant information while preserving essential spatial features.

The output of the CNN encoder 354 feeds into the fully connected layer 356 which processes these extracted features. The final output layer consists of three neurons, each corresponding to a specific navigation action: move forward, turn right at a 45-degree angle, or turn left at a −45-degree angle, as described in Table 1.

TABLE 1
The implemented UAV actions

| No. | Action Description |
|---|---|
| 1. | Move forward for a duration of 3 seconds. |
| 2. | Move forward along an angle of 45 degrees for a duration of 3 |
| | seconds. |
| 3. | Move forward along an angle of -45 degrees for a duration of 3 |
| | seconds |

These navigation actions are executed over a predefined duration of three seconds for making the UAV 358 precise, small adjustments to its flight path, minimizing the likelihood of collisions with nearby obstacles.

The system 300 is reinforced through the use of a DQN reward function. The reward function determines behaviour of the UAV 358 during navigation. The reward function penalizes the UAV 358 for collisions or actions that cause it to leave the predefined navigation area. Conversely, the reward function incentivizes actions that bring the UAV 358 closer to its destination. The progress of the UAV 358 is measured by calculating the difference between its previous position and its current position after each action. The reward function is structured to encourage the UAV 358 to minimize the number of steps required to reach its goal.

The reward is formulated by:

$$Reward = \{ \begin{matrix}0 & if collision ocurred or UAV exceeds the \\ limit of navigation area ( terminationsate ) \\ Use Equation ( 2 ) & otherwise\end{matrix} \qquad ( 1 )$$

Initially, a simulation may be performed for a UAV for purposes of training the reinforcement learning engine. During a simulation, in accordance with Equation (1), when the UAV 358 collides with either a pedestrian or a fixed obstacle, this event is considered a terminal state, and the simulation must restart from the start point as depicted in FIG. 1A. Another condition for terminating the simulation is when the UAV 358 flies away from the destination or into an open area with no pedestrians, either moving left or right. An empirical threshold is set for this deviation, limiting the UAV 358 to a maximum of 10 units away from the optimal path shown in FIG. 1A. After each navigation step, the system 300 applies a penalty by decreasing the reward by −0.1 to motivate the UAV 358 to reach its destination with the fewest steps. If the UAV 358 is within a 3-unit distance from the goal, the episode is terminated, and a new trial begins. After each step, the reward value is calculated as the difference between the previous distance to the destination and the current distance after the UAV 358 takes an action. If the UAV 358 moves away from the destination, the distance becomes negative. A distance formula is defined as follows:

$$Diff = ( {X}_{target} - {X}_{old} ) - ( {X}_{target} - {X}_{new} ) \qquad ( 2 )$$

where X_{target} represents the target location, X_{old} is previous position of the UAV 358 before the action, and X_{new} is its new position after the action is executed.

Additionally, the system 300 integrates a loss function 364, which optimizes the performance of the DQN. The loss function 364, derived from the Q-learning algorithm, combines the reward value with the predicted Q-values of both the current and subsequent states. The loss function 364 is determined by:

$$DQN\_loss = ( {r}_{t} + {λ ( {max}_{\hat{a}} ( Q ( {S}_{t + 1} , \hat{a} ) ) - Q ( {S}_{t} , {a}_{t} ) )}^{2} \qquad ( 3 )$$

where rₜ is the reward received by the DQN agent at time t, λ is the learning rate parameter that takes a value from 0 to 1. Q (Sₜ, aₜ) is the Q-value of the currently executed action at based on given state Sₜ (current depth), however Q(Sₜ₊₁, â) is the Q-value of the next state Sₜ₊₁. It is worth mentioning that the DQN_loss is used only during the updating step, and it utilizes a replay buffer 362 data that stores the transaction as tuples of state, action, reward, next state.

The system 300 utilizes the replay buffer 362 to store transaction data, including state, action, reward, and next state. The stored data is iteratively sampled to improve the accuracy of the DQN algorithm through backpropagation training, ensuring that the UAV 358 learns optimal navigation strategies over time. The replay buffer facilitates the training by providing diverse experience tuples, ensuring that the UAV 358 generalizes well to different scenarios.

In the self-supervised learning phase 364, the DQN is subjected to fine tuning using the depth images 350 stored in the replay buffer 362. The phase involves processing a triplet of images, a positive image representing the current state, an augmented version of the positive image, and a negative image representing a contrasting state.

In order to perform self-supervised learning, the system 300 computes a contrastive loss function 364-1, 364-2, . . . , 364-N by comparing the cosine similarity between the positive and negative images in the embedding space, as depicted in FIG. 3. The DQN weights are iteratively updated based on the number of self-supervised training epochs. The selection of positive and negative images is randomized during the fine-tuning phase. As the replay buffer size expands, the likelihood of obtaining a diverse set of images increases. The contrastive loss function is determined in accordance with the following equations:

$$cos\_sim ( u , v ) = ( u . v ) / ( \vert ( \vert u \vert ) \vert \cdot ‖ v ‖ ) \qquad ( 4 )$$

where cos_sim is the cosine function that computes the similarity of two vectors u and v in the embedding space.

$$Contrast loss = - log ( exp ( cos\_sim ( u , v + ) / τ ) ) / ( exp ( cos\_sim ( u , v + ) / τ ) ) + exp ( cos\_sim ( u , v - ) / τ ) )$$

where u represents the original positive image, v+is the augmented image generated by either rotation, scaling, or other imaging operations from the positive image as shown in FIG. 3., v−is the negative image. Finally, the τ is a hyper-parameter in the range (0.1 to 0.5) called the temperature coefficient that determines how much weight to give the computed similarity score. In a preferred embodiment, τ is set to 0.1.

Regarding the self-supervised learning phase, the embeddings for each image are generated through a pre-trained CNN encoder 364-1, 364-2, 364-N. For example, in a case that ResNet50is used in this phase, ResNet50 generates the feature embeddings for each of the triplet images, capturing spatial relations and abstract features relevant to the scene. This process fine-tunes the ability of the CNN to differentiate between similar and dissimilar states, improving navigation decisions in dynamic environments.

The final contrastive loss 364 is calculated using a scaling factor, denoted by the temperature coefficient t. This loss function is used to optimize the embeddings, ensuring that the positive and augmented images have embeddings close to each other (pulled together), while embedding of the negative image is pushed farther away. In other words, in the self-supervised learning with contrastive loss, “Pull” and “Push” serve as forces that structure data embeddings. Pull draws similar data points (images) together in the embedding space, aligning variations such as different augmented views of the same image to maintain consistency. In contrast, push drives apart dissimilar data points, preventing the embeddings from collapsing into a single point. By working together, these forces enable the model to capture meaningful differences within the data without labels, producing robust and discriminative representations.

By minimizing the loss, the self-supervised training phase 364 enhances the UAV 358 robustness in recognizing various states, even when faced with subtle environmental changes.

CNN encoders, such as 3D convolutional networks, may also be used to capture temporal information when depth images are gathered over time, providing a comprehensive understanding of dynamic environments. The networks can analyze voxel-level changes between consecutive frames to predict future obstacle movements, such as predicting the trajectory of moving pedestrians or vehicles. Additionally, recurrent neural networks (RNNs) like LSTM or gated recurrent units (GRUs) could be incorporated to handle temporal dependencies, further enhancing predictive capabilities of the system 300.

As the replay buffer 362 accumulates a wide variety of depth images, including those captured during edge cases, the DQN continues to improve its generalization capabilities. Over time, the UAV 358 becomes efficiently equipped to navigate through unpredictable and dynamic environments, avoiding collisions and optimizing flight paths even in complex scenarios.

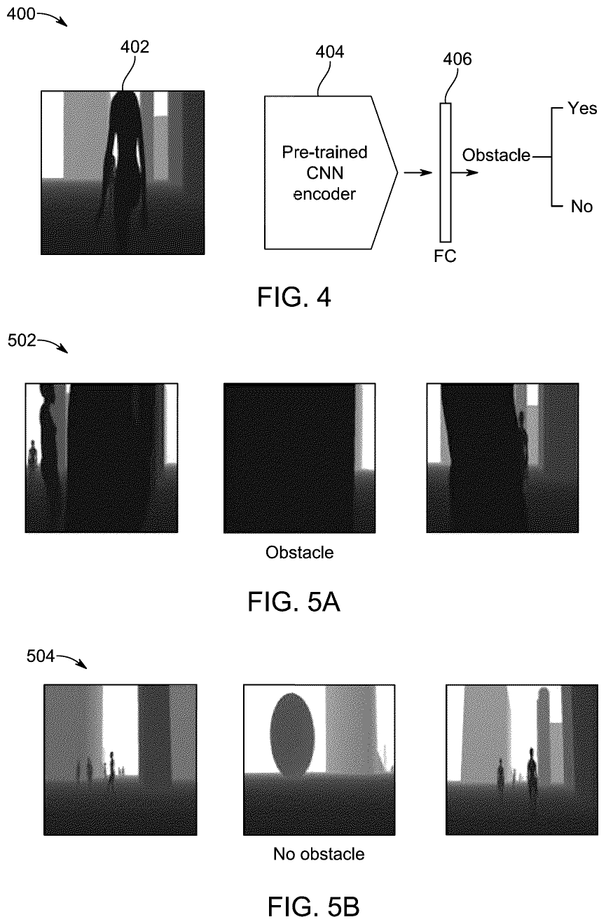

FIG. 4 illustrates an obstacle detection engine 400 integrated into a UAV navigation system. The obstacle detection engine 400 processes input data 402, such as depth images, from the UAV onboard depth camera, capturing the current state in real time. The depth image 402, provides information about the UAV surroundings, inputted into the obstacle detection engine 400. The obstacle detection engine 400 is configured to determine whether any detected object in the scene is an obstacle that could impede the UAV flight path.

The obstacle detection engine 400 uses a deep learning architecture built around a ResNet50 backbone network 404. The ResNet50 backbone network is a pre-trained convolutional neural network (CNN) composed of multiple layers of convolution operations that are optimized for hierarchical feature extraction. The network captures both low-level and high-level features from the input depth image 402, such as object edges, textures, shapes, and distances. The ResNet50 architecture incorporates residual connections to mitigate the problem of vanishing gradients, which often occur in deep networks, thereby allowing for more stable and efficient training even when dealing with complex image data.

Once the ResNet50 backbone network 404 extracts key features from the depth image, these features are passed through a fully connected (FC) layer 406, which consists of 512 neurons. The FC layer 406 is configured for transforming the high-dimensional feature space into a more compact and interpretable form, facilitating the decision-making process in the obstacle detection task. The reduction in dimensionality makes it easier for the obstacle detection engine 400 to classify the objects in the scene as either obstacles or non-obstacles.

Following the FC layer 406, the processed data is input into a softmax classifier, which produces the final output. The softmax classifier calculates the probability of the object being an obstacle by applying the softmax function to the output of the FC layer. The softmax function is defined as follows:

$$softmax ( {z}_{i} ) = \frac{{e}^{{z}_{i}}}{{\sum }_{j = 1}^{K} {e}^{{z}_{j}}}$$

where:
zᵢ represents the input score (logits) for class i,
e^{zi} presents the exponentiated score for class i,
K is the total number of classes (in this case, two classes: “Yes” for obstacle and “No” for non-obstacle), and

$${\sum }_{j = 1}^{K} {e}^{{z}_{j}}$$

is the sum of the exponentiated scores for all classes.

The softmax function normalizes the output scores into probabilities that sum to 1, making it easier to interpret confidence of the obstacle detection engine 400 in its predictions. In this case, the softmax function produces two outputs: a probability that the object is an obstacle (“Yes”) and a probability that the object is not an obstacle (“No”). The class with the highest probability is selected as the final output. For instance, if the softmax function produces a probability of 0.85 for “Yes” and 0.15 for “No”, the obstacle detection engine 400 classifies the object as an obstacle with 85% confidence.

The obstacle detection engine 400 is trained using a dataset that is continuously collected and stored in the replay buffer of the UAV navigation system. The replay buffer stores images captured during various UAV navigation tasks, along with labels indicating whether the UAV encountered an obstacle. Depth images 402 that lead to terminal states, such as UAV crashes or emergency stops, are labelled as “obstacle” data, while images captured during successful, unobstructed navigation are labelled as “no obstacle” data. The dataset is used to train the ResNet50 backbone network and the subsequent classification layers.

During training, the obstacle detection engine 400 distinguishes between different types of obstacles, including both stationary obstacles, such as buildings, trees, or other large structures and moving obstacles, such as pedestrians, vehicles, or other UAVs. The training process optimizes the obstacle detection engine 400 by minimizing a softmax cross-entropy loss function. The softmax cross-entropy loss is defined as:

$$Cross - Entropy Loss = - {\sum }_{i = 1}^{K} {y}_{i} log ( {\hat{y}}_{i} )$$

### Where:

yᵢ is the true label for class iii (1 for the correct class, 0 for others),
ŷᵢ is the predicted probability for class iii from the softmax function.

The cross-entropy loss measures the difference between the predicted probabilities and the actual labels. By minimizing this loss, the obstacle detection engine 400 improves its ability to accurately classify objects as obstacles or non-obstacles.

Furthermore, the obstacle detection engine 400 benefits from the replay buffer, which stores a diverse set of depth images representing various environments and obstacle types. The obstacle detection engine 400 thus learns to generalize across different conditions, including varying lighting, object sizes, and distances.

FIG. 5A shows a sample image 502 used for training the obstacle detection engine 400 of FIG. 4. The sample image 502 represents an obstacle, such as a pedestrian or another moving entity. The sample image 502 is classified as part of the “obstacle” class during the training process.

FIG. 5B illustrates another sample image 504 used for training the obstacle detection engine 400. In this instance, the image 504 represents a scene with no obstacles, which is classified as “no obstacle” during training phase of the obstacle detection engine 400. Such distinction between obstacle and no obstacle scenarios allows the UAV to refine its navigation performance by avoiding potential collisions.

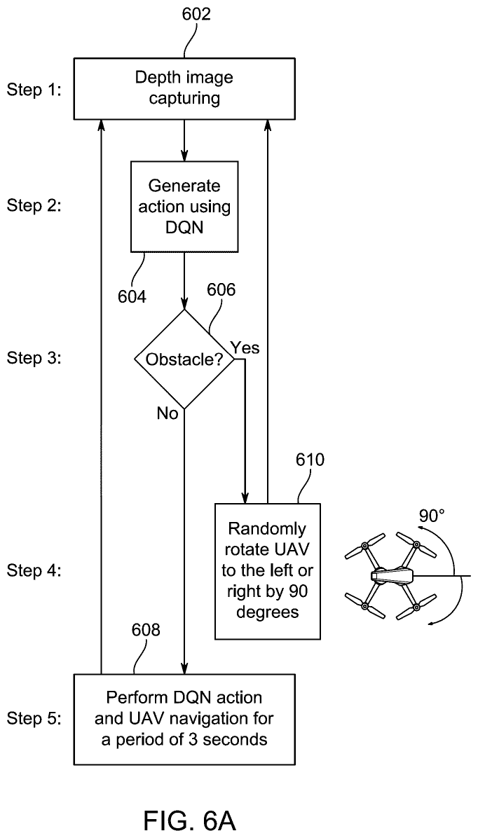

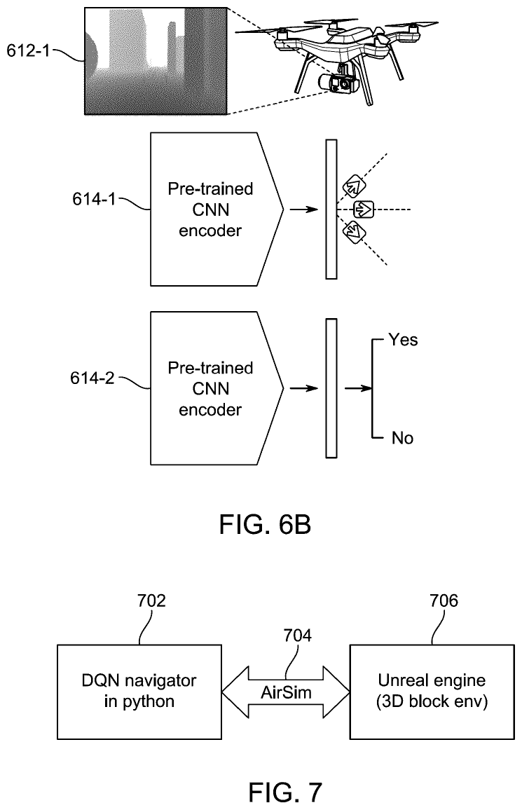

FIG. 6A illustrates a flowchart 600 for integrating the UAV navigation system with an obstacle detection engine. The UAV captures real-time depth images of its environment using onboard cameras, at step 602. These depth images are processed to evaluate the presence of obstacles in a flight path of the UAV and generate action using DQN at step 604. The obstacle detection engine classifies the captured depth image 612-1 as either containing an obstacle or no obstacle, at step 606.

When an obstacle is detected, the UAV computes an optimal evasive action based on the previously captured depth data, as well as information stored in the replay buffer from previous navigation trials, at step 610. In one aspect, the UAV is randomly rotated to the left or right by 90 degrees. If the obstacle is not detected, DQN action and UAV navigation is performed for a period of 3 seconds, at step 608.

FIG. 6B shows an extension of the process flow of the obstacle detection engine with the self-supervised learning system of the UAV. In this phase, the system continues to receive depth images 612-2 from the onboard cameras. The obstacle detection engine refines its classification of obstacles based on additional training data and trial and error process of the UAV. If an obstacle is classified as detected, the UAV adjusts its flight path in real-time to avoid collision. If no obstacle is detected, the UAV proceeds along its planned trajectory.

The pre-trained CNN encoder during phase 614-1 focuses on optimizing the UAV navigation through continuous learning based on rewards. The UAV receives sensor input, including depth images, and processes its current state relative to obstacles. The DQN generates control actions and receives rewards for positive navigation outcomes and penalties for collisions or moving away from the destination.

The pre-trained CNN encoder during phase 614-2 fine-tunes the CNN encoder by utilizing unlabeled data stored in the replay buffer. A triplet of images, positive, augmented, and negative, is processed using a contrastive loss function to improve feature representations. The objective is to increase the similarity between successful navigation states and reduce the similarity with unsuccessful states.

The present disclosure focuses on enhancing the training process, which is conducted in a simulation environment. The simulation provides a controlled setting where conditions can be modified for faster iteration. It should be understood that once trained in the simulation environment, the model is fine-tuned using new images captured from the real world.

In an embodiment, after initial training via simulation at least part of the system may be a ground-based unit while navigation control functions are performed onboard the UAV. In an alternative embodiment, after some initial training, the entire navigation control system may be performed onboard the UAV.

FIG. 7 illustrates an UAV framework 700 used for controlling UAV navigation within a 3D outdoor simulation environment. The environment 702 is generated using an open-source gaming engine, unreal engine, which facilitates the creation of complex outdoor scenes for testing UAV behavior in dynamic conditions. The simulation environment 702 is integrated with the AirSim package 704, which acts as an intermediary between the Unreal Engine environment and the UAV navigation system.

AirSim 704 is configured for managing the communication between onboard systems of the UAV and the simulation environment 702. Simulation is performed through the use of APIs having real-time data exchange between the UAV and the environment, allowing the UAV to process its surroundings, navigate obstacles, and adjust its flight path based on input from sensors and pre-programmed navigation algorithms.

The unreal engine 706, operating within the simulation environment 702, receives navigation commands from a Python-based navigator integrated into AirSim 704. These commands direct the UAV movements, such as forward flight, turning, and altitude adjustments, based on the real-time data received from the environment. The unreal engine 706 continuously interacts with the simulation environment 702 to test various navigation strategies and refine its behavior based on reinforcement learning.

The implemented parameter settings for the deep reinforcement learning phase are provided in Table 2. These parameters pertain to the maximum number of training episodes, the size of the replay buffer, the batch training size, and the DQN parameter update interval. The replay buffer stores past state-action-reward transitions, while the batch training size dictates the number of samples inputted to the UAV framework 700 during each batch. The DQN parameters update interval controls the timing for invoking self-supervised learning and reinforced training stages.

TABLE 2
Parameter Settings

| Parameters | value | |
|---|---|---|
| Max epochs | 2000 | |
| DQN update time | 100 | epochs |
| Batch size | 16 | |
| Replay buffer size | 10000 | |
| Learning rate | 0.0001 | |
| UAV step duration | 3 | seconds |

| | |
|---|---|
| Self-supervised training epochs | 100 |

Additionally, the evaluation metrics include the average distance to the objective and the average number of collisions during the testing phase, as well as the behavior of the loss function throughout the training phase. An initial evaluation has been performed using a simulated environment. It should be noted that the distance-to-goal metric is highly dependent on the characteristics of the simulated environment and must be carefully integrated into the design of the reward function to ensure the accuracy of the evaluation.

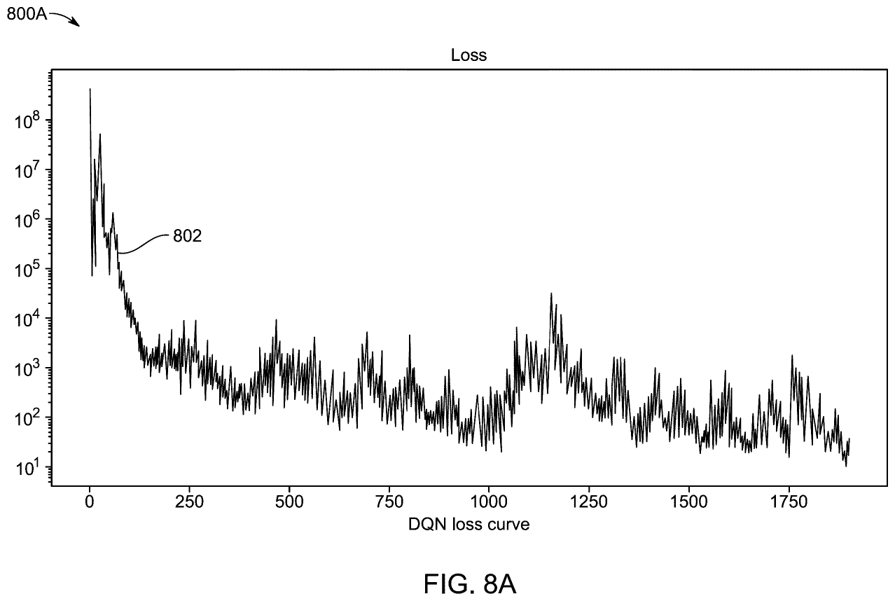

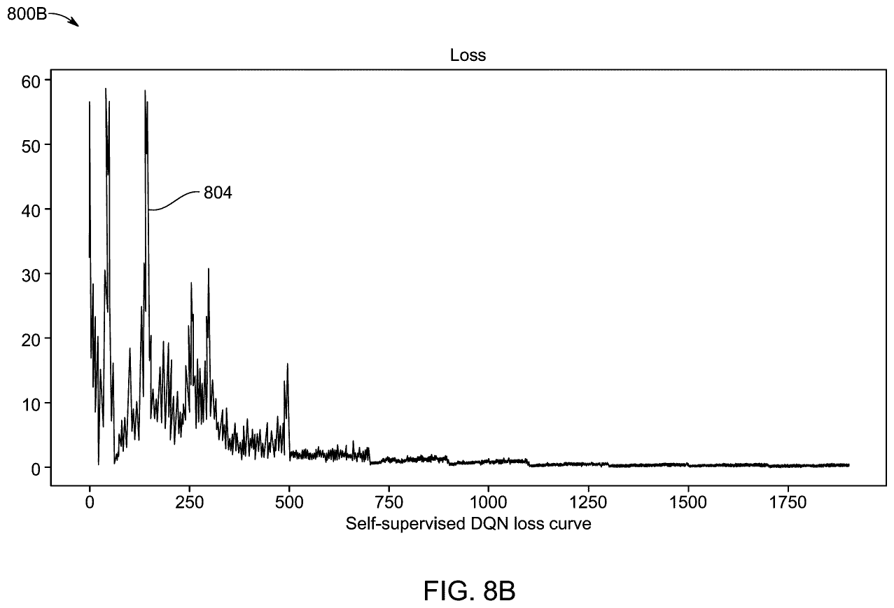

FIG. 8A illustrates a graph 800A of the loss curve 802 for the DQN during the training phase. The vertical axis represents the loss value, and the horizontal axis corresponds to the number of epochs in the training process. As shown in FIG. 8A, the DQN experiences significant fluctuations in loss values over the initial 1000 epochs, with values exceeding 100 in several instances. These fluctuations indicate instability and slower convergence during the training process. The loss value begins to gradually decrease and stabilize after 1000 epochs, yet the curve demonstrates persistent oscillations, with values remaining comparatively high. This reflects the limited efficacy of the DON in reducing the loss value based on the loss function during training.

FIG. 8B illustrates a graph 800B the loss curve 804 for the combined self-supervised DQN during the training phase. In contrast to the DQN shown in FIG. 8A, the self-supervised DQN exhibits a significantly improved convergence rate. While the initial loss values are relatively high during the first few hundred epochs, the loss curve 804 rapidly declines and approaches near-zero loss after approximately 1000 epochs. The self-supervised DQN demonstrates smoother convergence and more stable behavior compared to the conventional DQN. The superior performance of the self-supervised DQN is attributed to the increased efficacy of scene encoding, which accelerates the reduction of loss values, leading to improved learning efficiency.

As seen in FIG. 8A, the loss curve 802 for the DQN algorithm shows that it struggles to reduce the loss value effectively over the first thousand epochs, remaining highly volatile with large fluctuations. In contrast, FIG. 8B depicts the loss curve 804 for the self-supervised DQN, which exhibits a consistent reduction in loss values and a smoother convergence to near-zero values after the same number of epochs. The enhanced convergence is due to the integration of self-supervised learning fine-tuning that improve ability of the UAV to encode scene information more effectively, leading to faster training and better performance.

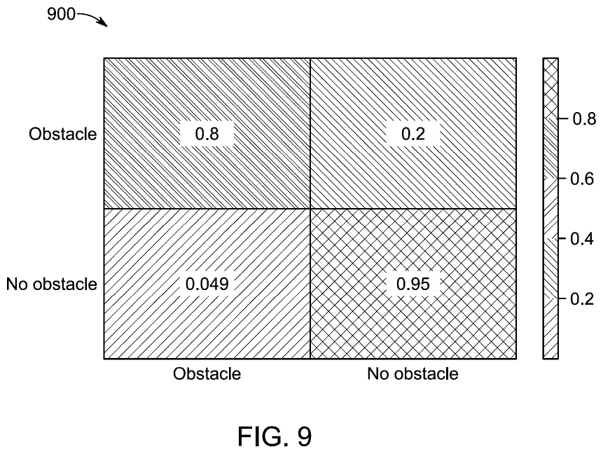

FIG. 9 illustrates the confusion matrix 900 for the obstacle detection engine integrated into the self-supervised Deep Q-Network (DQN) architecture. The confusion matrix 900 shows the classification accuracy of the obstacle detection engine, which was trained using a dataset consisting of 443 obstacle images and 1374 non-obstacle images. The dataset was split into a training set (70%) and a testing set (30%). The confusion matrix 900 indicates that the obstacle detection engine achieved an 80% accuracy rate for classifying obstacle images and a 95% accuracy rate for classifying non-obstacle images. The confusion matrix 900 shows classification performance, where the values 902 and 904 represent the true positive and false positive rates for obstacle detection, and the values 906 and 908 correspond to the true negative and false negative rates for non-obstacle classification.

Table 3 in the disclosure provides further performance analysis for the obstacle detection engine, comparing the number of collisions avoided by the UAV with and without the integrated detection engine. In terms of the average distance to the goal, the data indicates that the self-supervised DQN achieved a superior value of 157, meaning the UAV was positioned closer to the destination. However, the standard DQN algorithm resulted in a greater distance, suggesting that the UAV was still significantly further away from the destination point. The results from 10 test trials demonstrate that the UAV equipped with the obstacle detection engine covered nearly the same distance as a baseline engine but achieved a higher rate of successful obstacle avoidance, particularly in cases involving pedestrian detection.

TABLE 3
Performance analysis during testing phase

| | DQN | self-supervised DQN |
|---|---|---|
| The average distance | 178 | 157 |
| from the goal | | |
| Average collisions | 2 | 3 |
| Collied with obstacles | Orange_Ball | BP_person46 |
| | BP_person47 | BP_person49 |
| | | BP_person47 |
| | | BP_person50 |

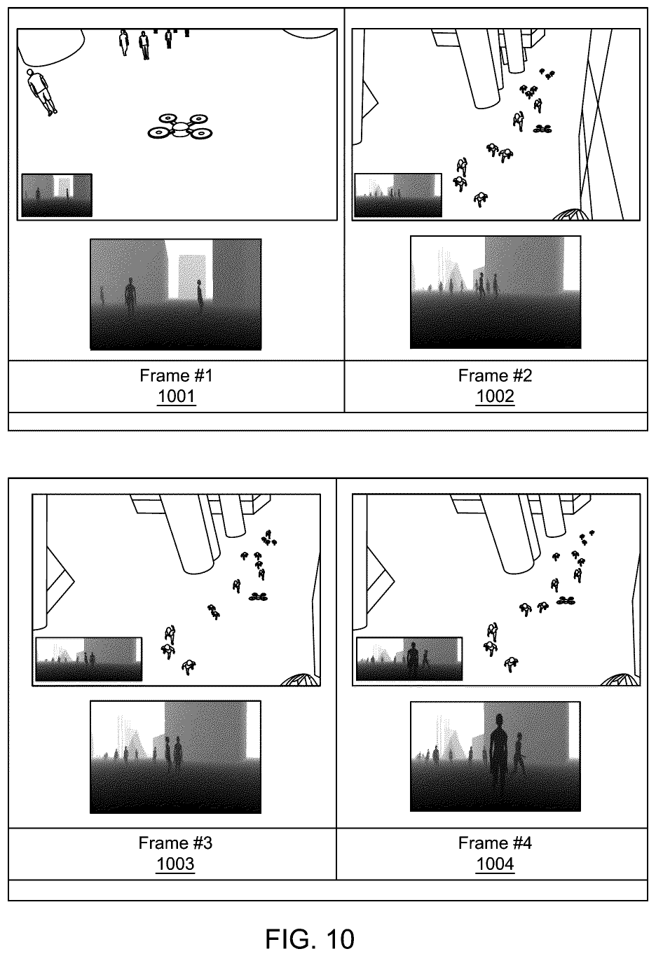

FIG. 10 provides a visual snapshot of the navigation environment during the obstacle detection process. The depth view of the UAV, captured in real time, is used to classify objects as obstacles or non-obstacles. Frame #1 shows the depth view 1001 of the UAV, where multiple pedestrians are present within the field of vision. The obstacle detection engine processes this image to identify moving entities. Frame #2 represents the classification output 1002, in which detected obstacles are highlighted in red, indicating that the UAV has identified them as potential collisions. Frame #3 show additional examples of depth view 1003 the UAV and Frame #4 show additional examples of depth view 1004, where the obstacle detection engine continues to classify objects in the environment, distinguishing between pedestrians and static obstacles.

TABLE 4
Performance analysis of obstacle detection engine

| | self-supervised | self-supervised DQN |
|---|---|---|
| | DQN | (with obstacle detection) |
| The average distance | 157 | 159 |
| from the goal | | |
| Average collisions | 3 | 2 |
| Collied with obstacles | BP_person46 | BP_person46 |
| | BP_person49 | BP_person50 |
| | BP_person47 | BP_person49 |
| | BP_person50 | |

The integration of the obstacle detection engine into the self-supervised DQN significantly enhances ability of the UAV to avoid both stationary and moving obstacles. As mentioned in Table 4, the obstacle detection engine detects pedestrians and other obstacles in real time. However, the challenge of avoiding moving obstacles remains, as some pedestrians may approach the UAV from unpredictable angles, resulting in occasional collisions. The obstacle detection engine continues to refine its accuracy over time by learning from previous navigation data.

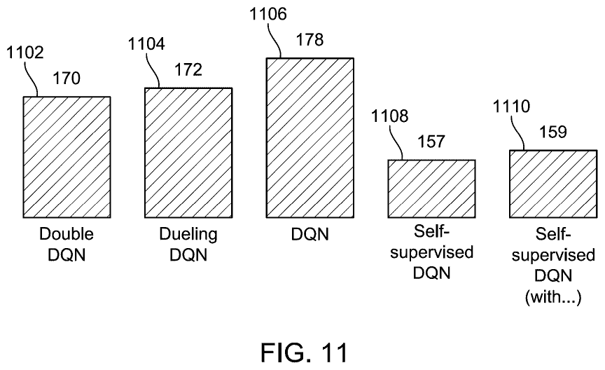

FIG. 11 illustrates the performance comparison between the self-supervised DQN and two other deep reinforcement learning algorithms, Double DQN and Dueling DQN. The horizontal axis represents the number of trials, and the vertical axis corresponds to the average distance travelled by the UAV before reaching the destination or colliding with obstacles. The performance analysis was conducted by evaluating the average distance from the destination for each algorithm, with a maximum of 10 steps allowed for each trial. The experiment was repeated times, and the average values are presented in FIG. 11.

The plot in FIG. 11 compares the performance of the self-supervised DQN algorithm 1102 of the present disclosure with the double DQN algorithm 1104 and the duelling DQN algorithm 1106. The self-supervised DQN algorithm 1102 shows the highest average distance travelled toward the destination compared to the double DQN algorithm 1104 and the duelling DQN algorithm 1106. The highest distance is attributed to the self-supervised learning component that accelerates the learning rate and enhances the UAV ability to encode environmental data, leading to more accurate and efficient navigation.

The double DQN algorithm 1104 and duelling DQN algorithm 1106, while effective in other deep reinforcement learning contexts, exhibit lower average distances travelled in this specific UAV navigation scenario. Such performance difference is due to the relatively simpler visual navigation task. As a result, the self-supervised DQN algorithm 1108 outperforms the other algorithms in terms of distance travelled before collision or goal achievement.

The comparison further illustrates the utility of self-supervised DQN 1110 in improving UAV navigation performance by handling variations in the input data and preventing overfitting. The self-supervised DQN 1110 algorithm also benefits from the integration of the obstacle detection system, which reduces the number of collisions, as reflected in the results shown in FIG. 11. The enhanced scene understanding allows the UAV to effectively navigate through complex environments, avoiding both static and dynamic obstacles while maintaining an optimal flight path.

In an exemplary embodiment, a navigation system for an autonomous vehicle comprises at least one camera mounted to the vehicle for continuously capturing image frames of a scene. The navigation system includes processing circuitry configured with a reinforcement learning engine receiving the captured image frames and generating a next control action by a deep Q-network for controlling movement of the vehicle based on a current state of the vehicle and a reward for a previous control action. The navigation system further includes a self-supervised learning engine for fine-tuning the deep Q-network. The navigation system further includes a vehicle actuator for maneuvering the vehicle based on the next control action.

In some embodiments, the autonomous vehicle is an unmanned aerial vehicle (UAV), and the next control action controls the direction of movement of the UAV.

In some embodiments, the navigation system further comprises an obstacle detection engine configured to receive the image frames of the scene from the at least one camera and determine if an object in the scene is a moving obstacle. The reinforcement learning engine is configured to receive the captured image frames and generate a next control action by the deep Q-network for controlling movement of the vehicle to avoid the moving obstacle.

In some embodiments, the obstacle detection engine includes a backbone network coupled to a fully connected classifier that outputs an obstacle class for the object.

In some embodiments, the self-supervised learning engine is configured to fine-tune a backbone network for the deep Q-network based on depth images stored in a replay buffer.

In some embodiments, the processing circuitry is further configured with a reward function to generate the reward. The reward function determines a reward value as a difference between a previous distance to a target location and a current distance after execution of the next control action.

In some embodiments, the self-supervised learning engine is configured to input a triplet of three images, one positive, one augmented, and one negative, to the backbone network and use a contrastive loss function to estimate a contrastive loss value.

In some embodiments, the reinforcement learning engine is configured to adjust the next control action in accordance with the contrastive loss value that indicates an amount of pull or an amount of push.

In some embodiments, the deep Q-network is a convolution neural network encoder.

In some embodiments, the navigation system further comprises a feedback circuit to feed the next control action back as an input to the deep Q-network.

In some embodiments, the processing circuitry is configured to train the deep Q-network using a loss function that is based on the reward and a Q-value of the next control action based on a state of the vehicle.

In another exemplary embodiment, a visual inspection system comprises a remote display terminal configured with a terminal transceiver. The visual inspection system further comprises an unmanned aerial vehicle (UAV) comprising an embedded transceiver for communicating with the remote display terminal via the terminal transceiver, and at least one camera mounted to the UAV for continuously capturing image frames of a scene, wherein the scene includes at least one object. The visual inspection system further comprises processing circuitry configured with a reinforcement learning engine receiving the captured image frames and generating a next control action by a deep Q-network for controlling movement of the vehicle to avoid the at least one moving object based on a current state of the vehicle and a reward for a previous control action. The visual inspection system further comprises a self-supervised learning engine for fine-tuning the deep Q-network. The visual inspection system further comprises a vehicle actuator for manoeuvring the UAV based on the next control action. The embedded transceiver is configured to transmit the captured image frames to the remote display terminal. The remote display terminal is configured to display the captured image frames.

In some embodiments, the visual inspection system further comprises an obstacle detection engine configured to receive the image frames of the scene from the at least one camera and determine if the object in the scene is an obstacle. The reinforcement learning engine is configured to receive the captured image frames and generate a next control action by the deep Q-network for controlling movement of the vehicle to avoid the obstacle.

In some embodiments, the obstacle detection engine includes a backbone network coupled to a fully connected classifier that outputs an obstacle class.

In some embodiments, the self-supervised learning engine is configured to fine-tune a backbone network for the deep Q-network based on depth images stored in a replay buffer.

In some embodiments, the processing circuitry is further configured with a reward function to generate the reward. The reward function determines a reward value as a difference between a previous distance to a target location and a current distance after execution of the control action.

In some embodiments, the self-supervised learning engine is configured to input a triplet of three images, one positive, one augmented, and one negative, to the backbone network and use a contrastive loss function to estimate a contrastive loss value.

In some embodiments, the reinforcement learning engine is configured to adjust the next control action in accordance with the contrastive loss value that indicates an amount of pull or an amount of push.

In some embodiments, the visual inspection system further comprises a feedback circuit to feed the next control action back as an input to the deep Q-network.

In some embodiments, the processing circuitry is configured to train the deep Q-network using a loss function that is based on the reward and a Q-value of the next control action based on a state of the UAV.

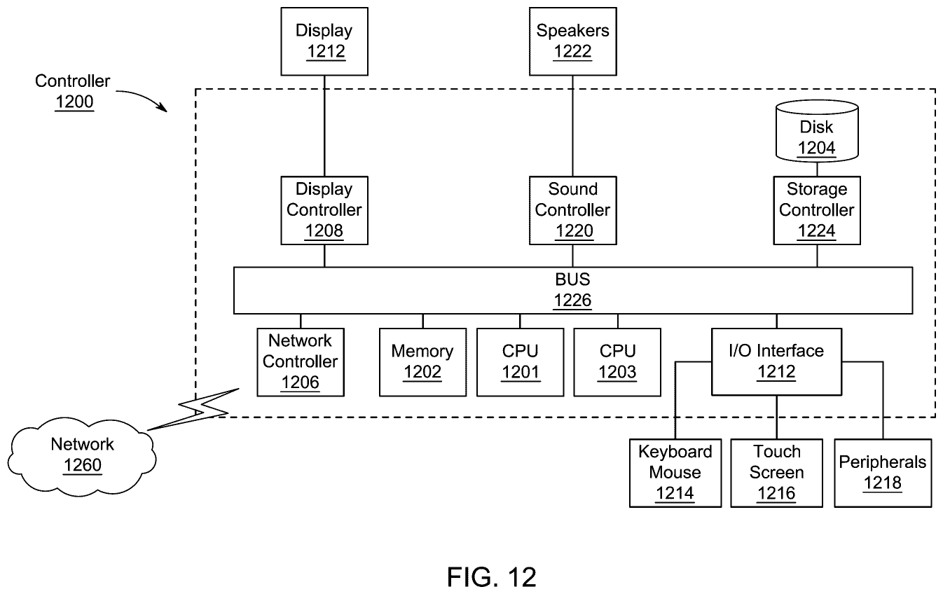

Next, further details of the hardware description of the computing environment according to exemplary embodiments are described with reference to FIG. 12. In FIG. 12, a controller 1200 is described and is representative of the navigation system 208 of FIG. 2A in which the controller is a computing device that includes a CPU 1201 which performs the processes described above. The process data and instructions may be stored in memory 1202. These processes and instructions may also be stored on a storage medium disk 1304 such as a hard drive (HDD) or portable storage medium or may be stored remotely.

Further, the disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk, or any other information processing device with which the computing device communicates, such as a server or computer.

Further, the disclosure may be provided as a utility application, background daemon, or component of an operating system, or a combination thereof, executing in conjunction with CPU 1201, 1203 and an operating system such as Microsoft Windows 7, Microsoft Windows 10, Microsoft Windows 11, UNIX, Solaris, LINUX, Apple MAC-OS, and other systems known to those skilled in the art.

The hardware elements to achieve the computing device may be realized by various circuitry elements, known to those skilled in the art. For example, CPU 1201 or CPU 1203 may be a Xenon or Core processor from Intel of America or an Opteron processor from AMD of America or may be other processor types that would be recognized by one of ordinary skill in the art. Alternatively, the CPU 1201, 1203 may be implemented on an FPGA, ASIC, PLD, or using discrete logic circuits, as one of ordinary skill in the art would recognize. Further, CPU 1201, 1203 may be implemented as multiple processors cooperatively working in parallel to perform the instructions of the inventive processes described above.

The computing device in FIG. 12 also includes a network controller 1206, such as an Intel Ethernet PRO network interface card from Intel Corporation of America, for interfacing with network 1260. As can be appreciated, the network 1260 can be a public network, such as the Internet, or a private network such as an LAN or WAN network, or any combination thereof, and can also include PSTN or ISDN sub-networks. The network 1260 can also be wired, such as an Ethernet network, or can be wireless such as a cellular network including EDGE, 3G, 4G, and 5G wireless cellular systems. The wireless network can also be WiFi, Bluetooth, or any other wireless form of communication that is known.

The computing device further includes a display controller 1208, such as a NVIDIA GeForce GTX or Quadro graphics adapter from NVIDIA Corporation of America for interfacing with display 1210, such as a Hewlett Packard HPL2445w LCD monitor. A general-purpose I/O interface 1212 interfaces with a keyboard and/or mouse 1214, as well as a touch screen panel 1216 on or separate from display 1210. The general-purpose I/O interface also connects to a variety of peripherals 1218, including printers and scanners, such as an OfficeJet or DeskJet from Hewlett Packard.

A sound controller 1220 is also provided in the computing device, such as Sound Blaster X-Fi Titanium from Creative, to interface with speakers/microphone 1222, thereby providing sounds and/or music.

The general-purpose storage controller 1224 connects the storage medium disk 1204 with communication bus 1226, which may be an ISA, EISA, VESA, PCI, or similar, for interconnecting all of the components of the computing device. A description of the general features and functionality of the display 1210, keyboard and/or mouse 1214, as well as the display controller 1208, storage controller 1224, network controller 1206, sound controller 1220, and general-purpose I/O interface 1212 is omitted herein for brevity as these features are known.

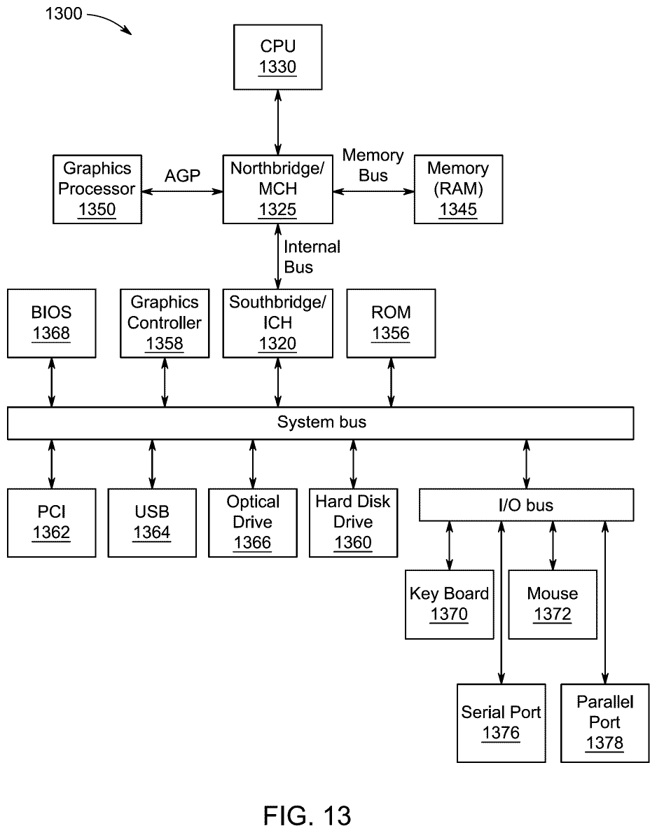

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown in FIG. 13.

FIG. 13 shows a schematic diagram of a data processing system, according to certain embodiments, for performing the functions of the exemplary embodiments. The data processing system is an example of a computer in which code or instructions implementing the processes of the illustrative embodiments may be located.

In FIG. 13, data processing system 1300 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1325. The NB/MCH 1325 also connects to the memory 1345 via a memory bus and connects to the graphics processor 1550 via an accelerated graphics port (AGP). The NB/MCH 1325 also connects to the SB/ICH 1320 via an internal bus (e.g., a unified media interface or a direct media interface). The CPU Processing unit 1330 may contain one or more processors and even may be implemented using one or more heterogeneous processor systems.

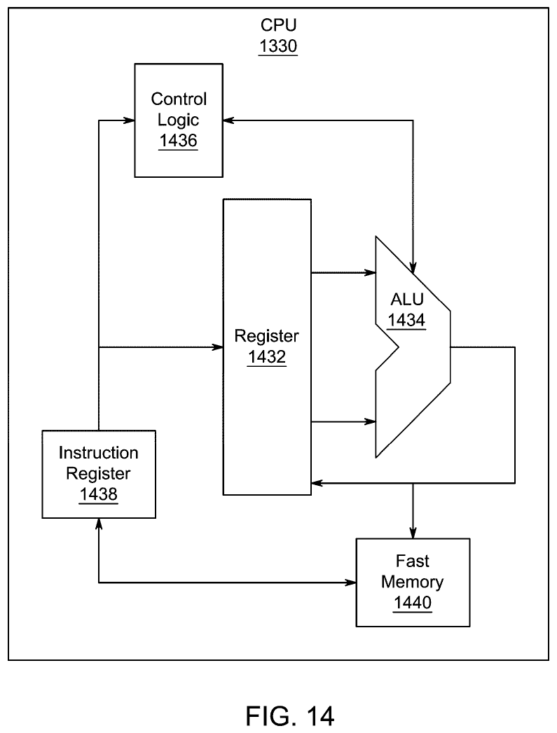

For example, FIG. 14 shows one implementation of CPU 1330. In one implementation, the instruction register 1438 retrieves instructions from the fast memory 1440. At least part of these instructions is fetched from the instruction register 1438 by the control logic 1436 and interpreted according to the instruction set architecture of the CPU 1330. Part of the instructions can also be directed to the register 1432. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be fed back into the register and/or stored in the fast memory 1440. According to certain implementations, the instruction set architecture of the CPU 1330 can use a reduced instruction set architecture, a complex instruction set architecture, a vector processor architecture, a very large instruction word architecture. Furthermore, the CPU 1330 can be based on the Von Neumann model or the Harvard model. The CPU 1330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architectures.

Referring again to FIG. 13, the data processing system 1300 can include that the SB/ICH 1320 is coupled through a system bus to an I/O Bus, a read-only memory (ROM) 1356, universal serial bus (USB) port 1364, a flash binary input/output system (BIOS) 1368, and a graphics controller 1358. PCI/PCIe devices can also be coupled to SB/ICH 1388 through a PCI bus 1362.

The PCI devices may include, for example, Ethernet adapters, add-in cards, and PC cards for notebook computers. The Hard disk drive 1360 and CD-ROM 1566 can use, for example, an integrated drive electronics (IDE) or serial advanced technology attachment (SATA) interface. In one implementation, the I/O bus can include a super I/O (SIO) device.

Further, the hard disk drive (HDD) 1360 and optical drive 1366 can also be coupled to the SB/ICH 1520 through a system bus. In one implementation, a keyboard 1370, a mouse 1372, a parallel port 1378, and a serial port 1376 can be connected to the system bus through the I/O bus. Other peripherals and devices that can be connected to the SB/ICH 1320 using a mass storage controller such as SATA or PATA, an Ethernet port, an ISA bus, an LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended backup load to be powered.

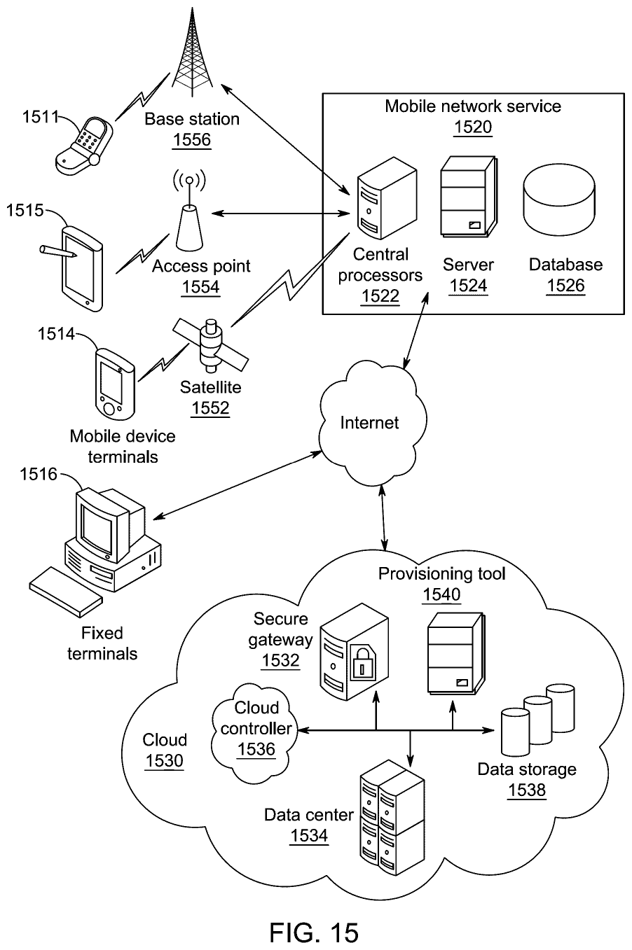

The functions and features described herein may also be executed by various distributed components of a system. For example, one or more processors may execute these system functions, wherein the processors are distributed across multiple components communicating in a network. The distributed components may include one or more client and server machines, such as cloud 1530 including a cloud controller 1536, a secure gateway 1532, a data center 1534, data storage 1538 and a provisioning tool 1540, and mobile network services 1520 including central processors 1522, a server 1524, and a database 1526, which may share processing, as shown in FIG. 15, in addition to various human interface and communication devices (e.g., display monitors 1516, smartphones 1510, tablets 1512, personal digital assistants (PDAs) 1514). The network may be a private network, such as an LAN, satellite 1552, or WAN 1554, or be a public network, such as the Internet. Input to the system may be received via direct user input and received remotely either in real-time or as a batch process. Additionally, some implementations may be performed on modules or hardware not identical to those described. Accordingly, other implementations are within the scope of the disclosure.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A navigation system for an autonomous vehicle, comprising:
at least one camera mounted to the vehicle for continuously capturing image frames of a scene;
processing circuitry configured with
a reinforcement learning engine receiving the captured image frames and generating a next control action by a deep Q-network for controlling movement of the vehicle based on a current state of the vehicle and a reward for a previous control action,
a self-supervised learning engine for fine-tuning the deep Q-network, wherein the self-supervised learning engine is configured to input a triplet of three images, one positive, one augmented, and one negative, to a backbone network, and use a contrastive loss function to estimate a contrastive loss value; and
a vehicle actuator for maneuvering the vehicle based on the next control action.

2. The navigation system of claim 1, wherein the autonomous vehicle is an unmanned aerial vehicle (UAV) and the next control action is to control a direction of movement of the UAV.

3. The navigation system of claim 1, further comprising
an obstacle detection engine configured to receive the image frames of the scene from the at least one camera and determine if an object in the scene is a moving obstacle,
wherein the reinforcement learning engine is configured to receive the captured image frames and generate a next control action by the deep Q-network for controlling movement of the vehicle to avoid the moving obstacle.

4. The navigation system of claim 3, wherein the obstacle detection engine includes a backbone network coupled to a fully connected classifier that outputs an obstacle class for the object.

5. The navigation system of claim 1, wherein the self-supervised learning engine is configured to fine-tune the backbone network for the deep Q-network based on depth images stored in a replay buffer.

6. The navigation system of claim 1, wherein the processing circuitry is further configured with a reward function to generate the reward, wherein the reward function determines a reward value as a difference between a previous distance to a target location and a current distance after execution of the next control action.

7. The navigation system of claim 5, wherein the self-supervised learning engine is configured to input the triplet of three images, including the augmented image generated by either rotation or scaling from the positive image.

8. The navigation system of claim 7, wherein the reinforcement learning engine is configured to adjust the next control action in accordance with the contrastive loss value that indicates an amount of pull or an amount of push.

9. The navigation system of claim 1, wherein the deep Q-network is a convolution neural network encoder.

10. The navigation system of claim 1, further comprising a feedback circuit to feed the next control action back as an input to the deep Q-network.

11. The navigation system of claim 1, wherein processing circuitry is configured to train the deep Q-network using a loss function that is based on the reward and a Q-value of the next control action based on a state of the vehicle.

12. A visual inspection system, comprising:
a remote display terminal configured with a terminal transceiver;
an unmanned aerial vehicle (UAV) comprising
an embedded transceiver for communicating with the remote display terminal via the terminal transceiver,
at least one camera mounted to the UAV for continuously capturing image frames of a scene, wherein the scene includes at least one object;
processing circuitry configured with
a reinforcement learning engine receiving the captured image frames and generating a next control action by a deep Q-network for controlling movement of the vehicle to avoid the at least one moving object based on a current state of the vehicle and a reward for a previous control action,
a self-supervised learning engine for fine-tuning the deep Q-network, wherein the self-supervised learning engine is configured to input a triplet of three images, one positive, one augmented, and one negative, to a backbone network, and use a contrastive loss function to estimate a contrastive loss value; and
a vehicle actuator for maneuvering the UAV based on the next control action,
wherein the embedded transceiver is configured to transmit the captured image frames to the remote display terminal, and
wherein the remote display terminal is configured to display the captured image frames.

13. The visual inspection system of claim 12, further comprising
an obstacle detection engine configured to receive the image frames of the scene from the at least one camera and determine if the object in the scene is an obstacle,
wherein the reinforcement learning engine is configured to receive the captured image frames and generate a next control action by the deep Q-network for controlling movement of the vehicle to avoid the obstacle.

14. The visual inspection system of claim 13, wherein the obstacle detection engine includes a backbone network coupled to a fully connected classifier that outputs an obstacle class.

15. The visual inspection system of claim 12, wherein the self-supervised learning engine is configured to fine-tune a backbone network for the deep Q-network based on depth images stored in a replay buffer.

16. The visual inspection system of claim 12, wherein the processing circuitry is further configured with a reward function to generate the reward, wherein the reward function determines a reward value as a difference between a previous distance to a target location and a current distance after execution of the control action.

17. The visual inspection system of claim 15, wherein the self-supervised learning engine is configured to input the triplet of three images, including the augmented image generated by either rotation or scaling from the positive image.

18. The visual inspection system of claim 17, wherein the reinforcement learning engine is configured to adjust the next control action in accordance with the contrastive loss value that indicates an amount of pull or an amount of push.

19. The visual inspection system of claim 12, further comprising a feedback circuit to feed the next control action back as an input to the deep Q-network.

20. The visual inspection system of claim 12, wherein processing circuitry is configured to train the deep Q-network using a loss function that is based on the reward and a Q-value of the next control action based on a state of the UAV.
